(19) United States
(12) Patent Application Publication
(10) Pub. No.: US 2018/0154864 A1
(43) Pub. Date: Jun. 7, 2018

(54) VEHICLE REMOTE CONTROL SYSTEM

(71) Applicant: Magna Electronics Inc., Auburn Hills, MI (US)

(72) Inventors: Norbert Kunze, Diez (DE); Prathyush Kumar Keshipeddy, Auburn Hills, MI (US)

(21) Appl. No.: 15/832,802

(22) Filed: Dec. 6, 2017

Related U.S. Application Data
(60) Provisional application No. 62/466,448, filed on Mar. 3, 2017.
(60) Provisional application No. 62/431,084, filed on Dec. 7, 2016.

(51) Int. Cl. B60R 25/102; G07C 9/00; H04M 1/725; B60R 25/24; B60R 25/01

(52) U.S. Cl. CPC B60R 25/102; G07C 9/00857; H04M 1/72527; B60R 2325/205; B60R 25/01; G07C 9/00119; G07C 2009/00888; B60R 25/24

(57) ABSTRACT

A vehicle control system includes a hatch opening control disposed at a vehicle and operable to open and close a hatch of the vehicle responsive to a triggering signal. The hatch includes one of a liftgate of the vehicle, a deck lid of the vehicle, a rear window of the vehicle and a rear door of the vehicle. A remote transmitter is operable to transmit the triggering signal responsive to a user input. The remote transmitter has at least two buttons. The user input includes one of (i) actuation of at least two buttons of the remote transmitter at the same time, (ii) repetitive actuation of one of the buttons at least three times with time gaps in between the actuations not exceeding a threshold time period, and (iii) actuation of at least two of the buttons in a predetermined actuation pattern.

### CROSS REFERENCE TO RELATED APPLICATIONS

The present application is related to U.S. provisional applications, Ser. No. 62/466,448, filed Mar. 3, 2017, and Ser. No. 62/431,084, filed Dec. 7, 2016, which are hereby incorporated herein by reference in their entireties.

### FIELD OF THE INVENTION

The present invention relates to trunk or hatch opening and closing devices and systems for vehicles and control devices for vehicle remote control systems.

### BACKGROUND OF THE INVENTION

Automated and propelled vehicle trunk lid, hatch and/or rear door openers are known and commercially available on vehicles. It is also known to have vehicle key fobs with several remote control keys or buttons for locking and unlocking the vehicle and for unlocking or opening the vehicle hatch. Also known are panic buttons as remote control keys for actuating audible vehicle alarms.

### SUMMARY OF THE INVENTION

The present invention provides a vehicle hatch control system that comprises a hatch opening control disposed at a vehicle and operable to open and close a hatch of the vehicle responsive to a triggering signal. The hatch comprises one of a liftgate of the equipped vehicle, a deck lid of the equipped vehicle, a rear window of the equipped vehicle and a rear door of the equipped vehicle. A remote transmitter is operable to transmit the triggering signal responsive to a user input. The remote transmitter has at least two buttons. The user input comprises one of (i) actuation of at least two of the buttons of the remote transmitter at the same time, (ii) repetitive actuation of one of the buttons at least three times with time gaps in between the actuations not exceeding a threshold time period, and (iii) actuation of at least two of the buttons in a predetermined sequence or actuation pattern.

Optionally, a remote transmitter may also be operable to transmit a panic signal to actuate an alarm or lights or horn of the vehicle. The vehicle is operable to transmit a confirmation signal back to the remote device or transmitter. The remote transmitter has human machine interface (HMI) means for bringing the confirmation signal to the human user's attention, such as via a visual alert or display or a haptic alert or audible alert or the like.

Therefore, the system of the present invention requires multiple actuations or inputs at the remote transmitter or key fob to open the vehicle hatch. Such multiple actuations are made in a predetermined manner or sequence or pattern, such that random or accidental actuation of one or more buttons at the remote transmitter will not open or unlock the vehicle hatch. The present invention thus provides enhanced control of the unlocking and opening of a vehicle hatch to limit or preclude accidental opening of the hatch by a person carrying the remote transmitter or key fob.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle that has an automatic opening and closing deck lid or hatch in accordance with the present invention;

FIG. 2 is a key fob suitable for use in the system of the present invention;

FIG. 3 is a block diagram showing an omnidirectional data transmission of a panic button signal from a remote transmitting device;

FIG. 4 is a block diagram showing a bidirectional data transmission of the panic button signal; and

FIG. 5 is a vehicle key with display.

### DESCRIPTION OF THE PREFERRED EMBODIMENTS

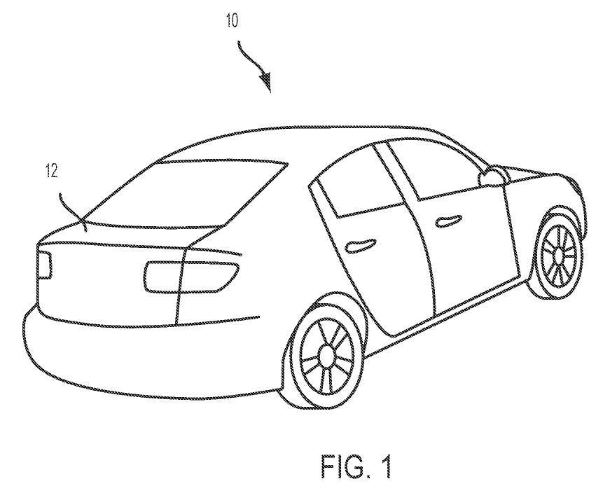

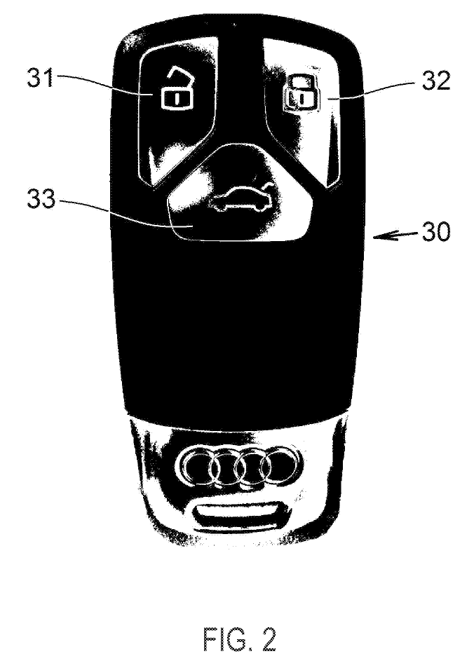

Referring now to the drawings and the illustrative embodiments depicted therein, a vehicle 10 (FIG. 1) has a deck lid or hatch 12 that is openable and closable responsive to actuation of a key fob 30 or the like (FIG. 2).

Openers for automated and propelled vehicle trunk lids, hatches, liftgates, rear windows and rear doors (hereinafter referred to as a ‘hatch’) typically comprise vehicle key fobs with several remote control keys for unlocking the vehicle or for starting or stopping the opening or closing of the vehicle hatch. More modern key fobs have displays, such as, for example, for indicating the vehicle locking status. So called Keyless Entry-Go systems allow the user to enter and start the vehicle without handling the key since the presence of the key in the driver's or passenger's pocket near the car is sufficient to unlock the vehicle. The presence of the key inside (starting enabled) and outside (door access enabled) the vehicle typically gets detected by a LF (wake up) and HF (code data exchange) radio transmission.

Remote key fobs, such as the key fob 30 shown in FIG. 2, typically possess at least three buttons, typically for remotely unlocking the vehicle (button 31) and locking the vehicle (button 32) the vehicle and typically another key 33 is provided for unlocking the vehicle hatch separately without unlocking the other doors, or for folding the top or opening the sunroof. When the vehicle hatch is propelled electrically, the according key fob button 33 is not just for unlocking the hatch, but also for opening, stopping and closing (with the toggle logic OPEN—STOP—CLOSE—STOP) the hatch in a propelled manner. In some cases, the fob has two separate buttons for opening and closing the hatch.

Some customers complain that they find their vehicle with their electrically propelled hatch wide open even in situations when they have left it in closed condition. Excluding faulty openings caused by electronics malfunction of the trunk lid motor control unit (which existed in past), these unintended openings are originated by unintended triggering of the remote key fob, such as when the driver puts the key fob into his or her pocket and/or sat on it and pushed the button 33 by that, while the vehicle was still in range of the remote control signal of the key fob.

The present invention provides a solution to these occurrences. As a first solution in accordance with the present invention, the present invention provides a system that requires more than one key or input to trigger the opening hatch remote signal. For example, it may be required to press three or two buttons at a time, such as, for example, the door unlock button 31 and the hatch opening button 33 on the key fob 30 together.

As a second solution in accordance with the present invention, it may be required that one (same) button gets triggered consecutively. For example, the hatch opening remote signal may be transmitted responsive to the door opening button 33 being repetitively actuated or triggered three times in a row, with time gaps in between the actuations not exceeding a threshold time period, such as, for example, about three seconds.

As a third solution in accordance with the present invention, it may be required to enter a sequence of button entries for generating the hatch opening remote signal. For example, it may be required to enter a sequence of three consecutive button entries, such as, for example, pressing the hatch opening button 33 first, then pressing the door unlock button 31 second and finally pressing the hatch opening button 33 again.

As an option to the second and third solutions, the key entry sequence may be editable by the customer. For example, a custom key sequence may be entered and stored by absolving a prior learning sequence procedure which stays valid until it gets relearned. In a driver initiated learning phase, the driver may enter the desired key sequence in a timely fashion as desired. He or she may set a tolerance band in which the run time key time can be entered for successful triggering of the hatch opening.

A very similar problem to be solved by the present invention is that a remote transmitter or key fob user may accidentally press the “panic” button on their transmitter, causing the vehicle alarm to be actuated and remain actuated until it gets noticed by the user and turned off by pressing the button again or until the vehicle battery dies. Currently, the most common problem is that, if the button got pressed by mistake, the user may not notice turning the panic alarm off and the vehicle battery may drain. This problem may be especially concerning in apartments where drivers park their cars within the range of key fob and possibly may not be able to physically see the vehicle. The user may be surprised the next day when he or she tries to start the vehicle and the vehicle won't start because the battery is drained due to the panic alarm operating overnight.

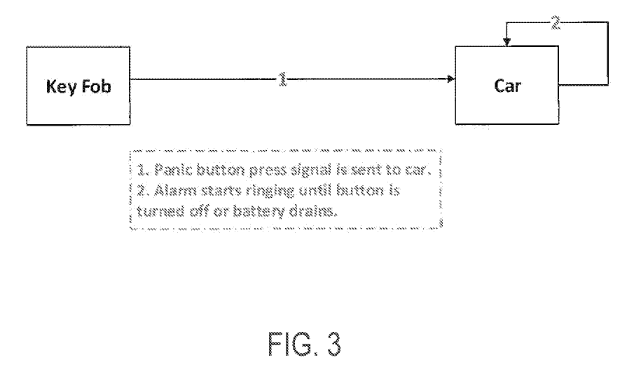

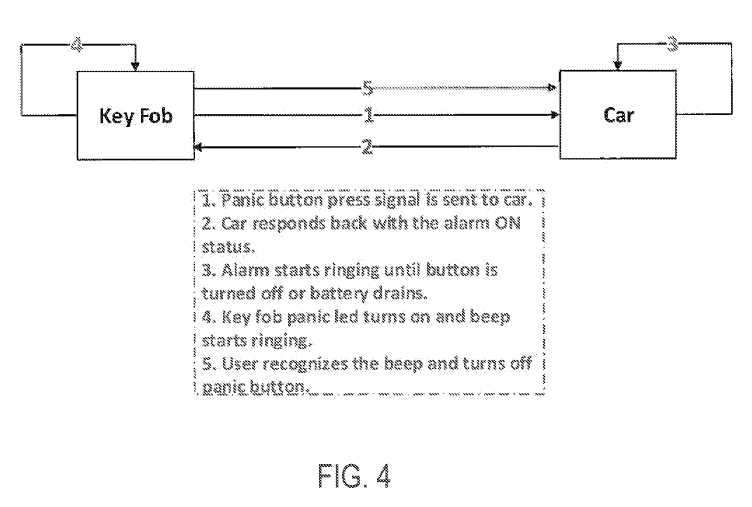

To avoid this problem, a small LED flash light or indicator on the remote transmitting device may glow when the button gets pressed and/or a speaker of the remote transmitting device may produce an audible sound or beeping sound may be actuated or a device inside the fob vibrates when the panic alarm is engaged. This way even when the vehicle cannot be seen physically, but may be parked within the key fob range, especially in apartments, the vehicle driver or owner may be able to recognize his/her mistake and turn off the vehicle's panic button. Instead of having an omnidirectional transmission such as shown in FIG. 3, there may be a bidirectional transmission (FIG. 4) for providing the feedback on the transmitter.

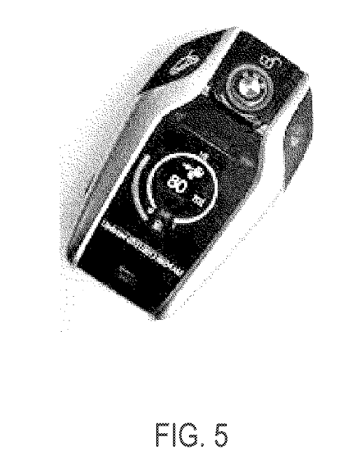

Optionally, instead of a small LED indicator, the transmitter may comprise a display for displaying the panic alarm status. For example, the BMW i8 has a key (FIG. 5) showing some vehicle conditions such as locking status, charge or fuel level information or whether the engine running, transmitted by the vehicle. The system of the present invention may utilize a key of this type to provide additional display functions to indicate to the driver that the vehicle alarm has been activated. The user can then deactivate the alarm or may check on the vehicle to make sure it was an accidental activation of the alarm and not a possible break in at the vehicle. The fob may indicate whether the alarm was caused by a user action or due to a break in at the vehicle (such as when the alarm is generated by a security system of the vehicle). The fob may also start a phone call to the owner's mobile or may communicate or transmit or send a message via BLUETOOTH® in case of a break in at the vehicle for situations where the fob is not in the user's or owner's pocket but is instead, for example, in a coat pocket at a clothes rack in a restaurant or elsewhere.

The system may utilize aspects of the systems described in U.S. Pat. No. 9,068,390 and/or U.S. Publication No. US 2011-0043633, published Feb. 24, 2011, which are hereby incorporated herein by reference in their entireties.

Changes and modifications to the specifically described embodiments may be carried out without departing from the principles of the present invention, which is intended to be limited only by the scope of the appended claims as interpreted according to the principles of patent law.

1. A vehicle control system, said vehicle control system comprising:
a hatch opening control disposed at a vehicle and operable to open and close a hatch of the vehicle responsive to a triggering signal, wherein the hatch comprises one of a liftgate of the equipped vehicle, a deck lid of the equipped vehicle, a rear window of the equipped vehicle and a rear door of the equipped vehicle;
a remote transmitter operable to transmit the triggering signal responsive to a user input, wherein the remote transmitter has at least two buttons; and
wherein the user input comprises one of (i) actuation of at least two of the buttons of the remote transmitter at the same time, (ii) repetitive actuation of one of the buttons at least three times with time gaps in between the actuations not exceeding a threshold time period, and (iii) actuation of at least two of the buttons in a predetermined actuation pattern.

2. The vehicle control system of claim 1, wherein the remote transmitter has at least three buttons.

3. The vehicle control system of claim 2, wherein the buttons comprise (i) a door unlock button, (ii) a door lock button and (iii) a hatch release button.

4. The vehicle control system of claim 3, wherein the user input comprises actuation of the door unlock button and the hatch release button at the same time.

5. The vehicle control system of claim 3, wherein the user input comprises repetitive actuation of the hatch release button at least three times with time gaps in between the actuations not exceeding a threshold time period.

6. The vehicle control system of claim 3, wherein the user input comprises actuation of at least the hatch release button and at least one of the door unlock button and the door lock button in a predetermined actuation pattern.

7. The vehicle control system of claim 1, wherein the user input comprises actuation of at least two buttons of the remote transmitter at the same time.

8. The vehicle control system of claim 1, wherein the user input comprises repetitive actuation of one of the buttons at least three times with time gaps in between the actuations not exceeding a threshold time period.

9. The vehicle control system of claim 1, wherein the user input comprises actuation of at least two of the buttons in a predetermined actuation pattern.

10. The vehicle control system of claim 9, wherein the predetermined actuation pattern is programmable by an owner of the vehicle.

11. The vehicle control system of claim 1, wherein the remote transmitter is operable to actuate an alarm of the vehicle from a location remote from the vehicle.

12. The vehicle control system of claim 11, wherein the vehicle communicates a signal to the remote transmitter when the remote transmitter actuates the alarm of the vehicle, and wherein, responsive to receipt of the signal, the remote transmitter generates an indication to the user that the vehicle alarm was actuated by the remote transmitter.

13. The vehicle control system of claim 12, wherein the indication comprises actuation of a light emitting diode of the remote transmitter, a display device of the remote transmitter, an audible device of the remote transmitter and/or a haptic device of the remote transmitter.

14. The vehicle control system of claim 1, wherein the vehicle communicates a signal to the remote transmitter when an alarm of the vehicle is actuated by a security system of the vehicle, and wherein, responsive to receipt of the signal, the remote transmitter generates an alert to the user that the vehicle alarm was actuated by the security system of the vehicle.

15. The vehicle control system of claim 14, wherein the remote transmitter, responsive to receiving the signal from the vehicle, communicates a signal to the user's mobile phone.

16. A vehicle control system, said vehicle control system comprising:
a hatch opening control disposed at a vehicle and operable to open and close a hatch of the vehicle responsive to a triggering signal, wherein the hatch comprises one of a liftgate of the equipped vehicle, a deck lid of the equipped vehicle, a rear window of the equipped vehicle and a rear door of the equipped vehicle;
a remote transmitter operable to transmit the triggering signal responsive to a user input, wherein the remote transmitter has at least three buttons;
wherein the user input comprises actuation of at least two of the buttons in a predetermined actuation pattern;
wherein the predetermined actuation pattern is programmable by an owner of the vehicle; and
wherein the remote transmitter is operable to actuate an alarm of the vehicle from a location remote from the vehicle.

17. The vehicle control system of claim 16, wherein the vehicle communicates a first signal to the remote transmitter when the remote transmitter actuates the alarm of the vehicle, and wherein, responsive to receipt of the first signal, the remote transmitter generates an indication to the user that the vehicle alarm was actuated by the remote transmitter.

18. A vehicle control system, said vehicle control system comprising:
a hatch opening control disposed at a vehicle and operable to open and close a hatch of the vehicle responsive to a triggering signal, wherein the hatch comprises one of a liftgate of the equipped vehicle, a deck lid of the equipped vehicle, a rear window of the equipped vehicle and a rear door of the equipped vehicle;
a remote transmitter operable to transmit the triggering signal responsive to a user input, wherein the remote transmitter has at least two buttons;
wherein the remote transmitter is operable to actuate an alarm of the vehicle from a location remote from the vehicle;
wherein the vehicle communicates a first signal to the remote transmitter when the remote transmitter actuates the alarm of the vehicle, and wherein, responsive to receipt of the first signal, the remote transmitter generates an indication to the user that the vehicle alarm was actuated by the remote transmitter; and
wherein the vehicle communicates a second signal to the remote transmitter when the alarm of the vehicle is actuated by a security system of the vehicle, and wherein, responsive to receipt of the second signal, the remote transmitter generates an alert to the user that the vehicle alarm was actuated by the security system of the vehicle.

19. The vehicle control system of claim 18, wherein the indication comprises actuation of a light emitting diode of the remote transmitter, a display device of the remote transmitter, an audible device of the remote transmitter and/or a haptic device of the remote transmitter.

20. The vehicle control system of claim 18, wherein the remote transmitter, responsive to receipt of the second signal from the vehicle, communicates a signal to the user's mobile phone.
